(19) United States
(12) Patent Application Publication
(10) Pub. No.: US 2017/0230244 A1
(43) Pub. Date: Aug. 10, 2017

(54) CLASSIFICATION METHOD, AND INFORMATION PROCESSING APPARATUS

(71) Applicant: FUJITSU LIMITED, Kawasaki-shi (JP)

(72) Inventors: Tetsuya UCHIUMI, Kawasaki (JP); Ken YOKOYAMA, Kawasaki (JP); Yukihiro WATANABE, Kawasaki (JP); Hiroshi OTSUKA, Kawasaki (JP); Masahiro ASAOKA, Kawasaki (JP); Reiko KONDO, Yamato (JP)

(73) Assignee: FUJITSU LIMITED, Kawasaki-shi (JP)

(21) Appl. No.: 15/416,579

(22) Filed: Jan. 26, 2017

(30) Foreign Application Priority Data
Feb. 9, 2016 (JP) 2016-022700

(51) Int. Cl. H04L 12/24; H04L 29/08

(52) U.S. Cl. CPC H04L 41/0866; H04L 67/10; H04L 67/1097

(57) ABSTRACT

A method includes calculating a first feature amount for each of a plurality of apparatuses, performing first clustering on the first feature amount, generating a first rule, storing the first rule into a memory, calculating a second feature amount, performing second clustering on the second feature amount, generating a second rule, storing the second rule into the memory, performing third clustering on the plurality of apparatuses based on the first result of the first clustering and the second result of the second clustering, generating a third rule related to attributes, and storing the third rule into the memory.

### CROSS-REFERENCE TO RELATED APPLICATION

This application is based upon and claims the benefit of priority of the prior Japanese Patent Application No. 2016-022700, filed on Feb. 9, 2016, the entire contents of which are incorporated herein by reference.

### FIELD

The embodiments discussed herein are related to a technology which classifies apparatuses in relation to a characteristic of a resource use.

### BACKGROUND

For example, in an information system in which a plurality of virtual servers simultaneously operate, resources such as a central processing unit (CPU), a disk, and a network are assigned to the virtual servers. That is, each virtual server performs a process of the virtual server in a state where usage (hereinafter, referred to as permissible usage) which is permitted to each resource is secured.

However, in a case where the permissible usage of each of the resources assigned to the corresponding virtual server is inappropriate, the resources may be insufficient in some virtual servers, and a process in such apparatus may be delayed.

Related technologies are disclosed in, for example, Japanese Laid-open Patent Publication No. 2015-11362, Japanese Laid-open Patent Publication No. 2010-277208, International Publication Pamphlet No. WO 2013/140524, Japanese Laid-open Patent Publication No. 2004-206495, and Japanese Laid-open Patent Publication No. 2014-191365.

### SUMMARY

According to an aspect of the invention, a non-transitory computer-readable storage medium storing a program for causing a computer to execute a process, the process includes calculating, for each of a plurality of apparatuses, a first feature amount that indicates an association between resource uses according to a combination of resources based on first logs related to the resources which are respectively used by the plurality of apparatuses, performing first clustering on the first feature amount of each of the plurality of apparatuses, generating a first rule related to the association based on a first result of the first clustering, the first rule corresponding to a procedure that produces a substantially equal result to the first result of the first clustering, storing the first rule into a memory, calculating, based on the first logs, a second feature amount that indicates a resource usage in each time slot for each of the resources which are respectively used by the plurality of apparatuses, performing second clustering on the second feature amount of each of the plurality of apparatuses, generating a second rule related to the resource usage based on a second result of the second clustering, the second rule corresponding to a procedure that produces a substantially equal result to the second result of the second clustering, storing the second rule into the memory, performing third clustering on the plurality of apparatuses based on the first result of the first clustering and the second result of the second clustering, generating a third rule related to attributes based on a third result of the third clustering, the attributions indicating types of the plurality of apparatus, and storing the third rule into the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a network according to Embodiment 1;

FIG. 2 is a diagram illustrating an example of a configuration of modules of a classification apparatus;

FIG. 3 is a diagram illustrating an example of a configuration of modules of a first phase unit;

FIG. 4 is a flowchart illustrating a flow of a first phase process;

FIG. 5 is a diagram illustrating an example of a correlation coefficient table;

FIG. 6 is a flowchart illustrating a flow of a first feature amount calculation process;

FIG. 7 is a diagram illustrating an example of a correlation cluster table;

FIG. 8 is a diagram illustrating an example of a first classification rule;

FIG. 9 is a diagram illustrating an example of a CPU usage table;

FIG. 10 is a diagram illustrating an example of a disk usage table;

FIG. 11 is a diagram illustrating an example of a network usage table;

FIG. 12 is a flowchart illustrating a flow of a second feature amount calculation process;

FIG. 13 is a flowchart illustrating a flow of a second clustering process;

FIG. 14 is a diagram illustrating an example of a time cluster table;

FIG. 15 is a diagram illustrating an example of a second classification rule related to CPU usage;

FIG. 16 is a diagram illustrating an example of the second classification rule related to disk usage;

FIG. 17 is a diagram illustrating an example of the second classification rule related to network usage;

FIG. 18 is a diagram illustrating an example of an integration cluster table;

FIG. 19 is a diagram illustrating an example of a third classification rule;

FIG. 20 is a diagram illustrating an example of a configuration of modules of a second phase unit;

FIG. 21 is a flowchart illustrating a flow of a second phase process;

FIG. 22 is a flowchart illustrating a flow of a third feature amount calculation process;

FIG. 23 is a diagram illustrating an example of a correlation coefficient table;

FIG. 24 is a diagram illustrating the cluster table;

FIG. 25 is a flowchart illustrating a flow of a fourth feature amount calculation process;

FIG. 26 is a diagram illustrating an example of the CPU usage table;

FIG. 27 is a diagram illustrating an example of the disk usage table;

FIG. 28 is a diagram illustrating an example of the network usage table;

FIG. 29 is a diagram illustrating an example of a configuration of a network according to Embodiment 2;

FIG. 30 is a diagram illustrating an example of a configuration of modules of a classification apparatus according to Embodiment 2;

FIG. 31 is a diagram illustrating an example of a configuration of modules of a classification apparatus according to Embodiment 2; and

FIG. 32 is a functional block diagram of a computer.

### DESCRIPTION OF EMBODIMENTS

In a case where assignment of the resources is controlled such that each of the virtual servers smoothly operates, it is desired to grasp a characteristic type, to which the virtual server belongs, in relation to a resource use. However, it is not easy for a person who is not well aware of process content and an operational form of each of the virtual servers to classify virtual servers according to a characteristic of the resource use.

An object of a technology disclosed in embodiments is to generate an apparatus classification rule which is more suitable for classification focused on a characteristic of a resource use.

### Embodiment 1

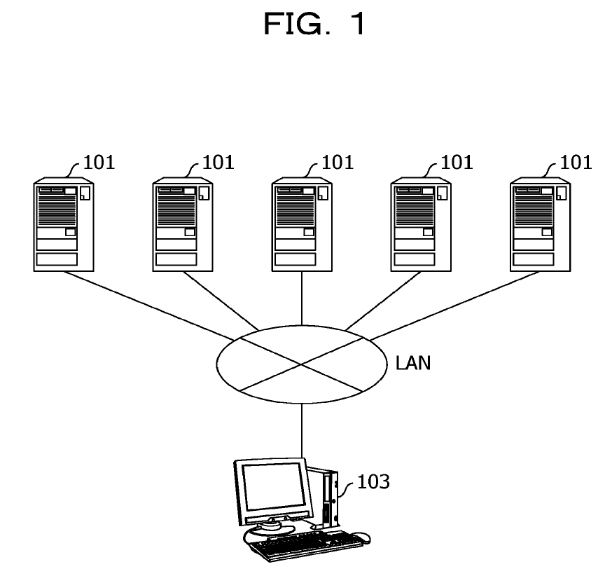

FIG. 1 illustrates an example of a configuration of a network. A plurality of physical servers 101 are coupled to a local area network (LAN). In addition, a storage apparatus may be coupled to the LAN.

It is assumed that a plurality of virtual servers are deployed in the physical servers 101. Each of the virtual servers uses common resources. That is, each of the virtual servers shares resources such as a CPU, a memory, a disk, and a network.

In addition, a management apparatus that manages the physical servers 101 is deployed in any one of the physical servers 101. The management apparatus manages permissible usage of each resource which is assigned to, for example, each of the virtual servers.

A status of a use of each resource in each virtual server is recorded as a log. The log is maintained in the management apparatus or the virtual server.

A classification apparatus 103 is an apparatus that classifies the virtual server according to the status of the use of the resource in each virtual server. The classification apparatus 103 operates through two phases.

In a first phase, the classification apparatus 103 performs clustering based on a log of each virtual server included in a sample set, and generates a rule for classifying a virtual server which is a classification target, similarly to the clustering.

In a second phase, the classification apparatus 103 classifies the virtual server which is the classification target according to the rule based on the log of the virtual server which is the classification target. That is, in the embodiment, in the second phase, a virtual server other than the sample is classified by generating the classification rule in the first phase.

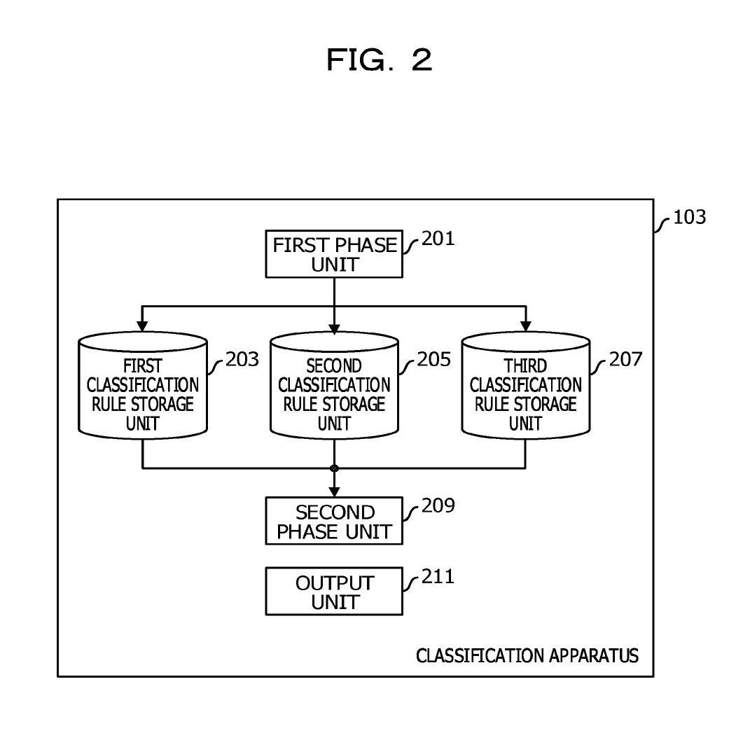

FIG. 2 illustrates an example of a configuration of modules of the classification apparatus 103. The classification apparatus 103 includes a first phase unit 201, a first classification rule storage unit 203, a second classification rule storage unit 205, a third classification rule storage unit 207, a second phase unit 209, and an output unit 211.

The first phase unit 201 performs a first phase process. The first classification rule storage unit 203 stores a first classification rule. The second classification rule storage unit 205 stores a second classification rule. The third classification rule storage unit 207 stores a third classification rule. The second phase unit 209 performs a second phase process. The first phase process, the second phase process, the first classification rule, the second classification rule, and the third classification rule will be described later. The output unit 211 outputs a result of classification.

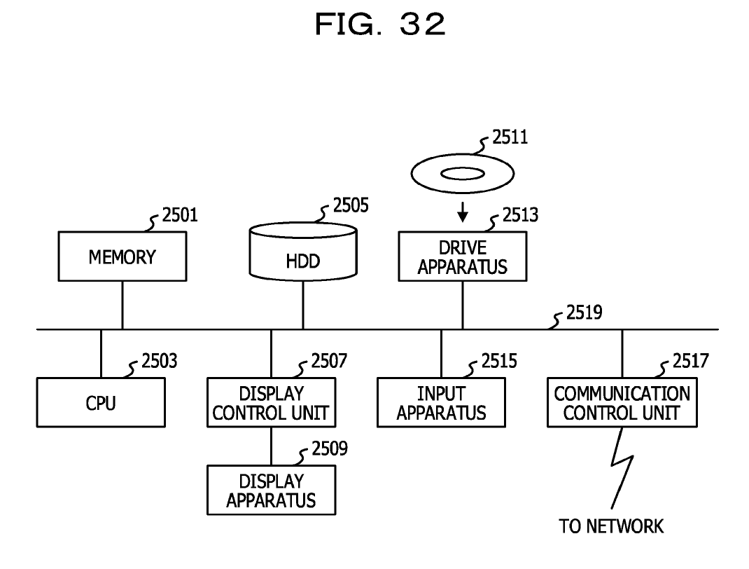

The above-described first phase unit 201, the second phase unit 209, and the output unit 211 are realized using hardware resources (for example, see FIG. 32) and a program which causes a processor to perform processes which will be described below.

The above-described first classification rule storage unit 203, the second classification rule storage unit 205, and the third classification rule storage unit 207 are realized using the hardware resources (for example, see FIG. 32).

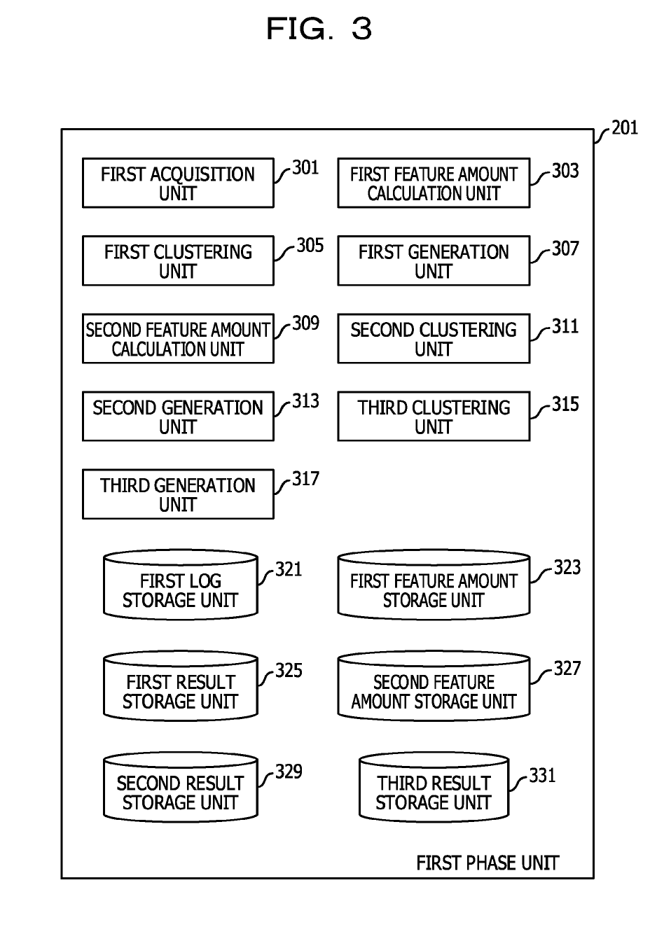

FIG. 3 illustrates an example of a configuration of modules of the first phase unit 201. The first phase unit 201 includes a first acquisition unit 301, a first feature amount calculation unit 303, a first clustering unit 305, a first generation unit 307, a second feature amount calculation unit 309, a second clustering unit 311, a second generation unit 313, a third clustering unit 315, a third generation unit 317, a first log storage unit 321, a first feature amount storage unit 323, a first result storage unit 325, a second feature amount storage unit 327, a second result storage unit 329, and a third result storage unit 331.

The first acquisition unit 301 acquires logs of respective resources in the virtual server which belongs to the sample set. The first feature amount calculation unit 303 performs a first feature amount calculation process. The first clustering unit 305 performs a first clustering process. The first generation unit 307 performs a first generation process. The second feature amount calculation unit 309 performs a second feature amount calculation process. The second clustering unit 311 performs a second clustering process. The second generation unit 313 performs a second generation process. The third clustering unit 315 performs a third clustering process. The third generation unit 317 performs a third generation process. Also, the first feature amount calculation process, the second feature amount calculation process, the first clustering process, the second clustering process, the third clustering process, the first generation process, the second generation process, and the third generation process will be described later.

The first log storage unit 321 stores the logs of the respective resources in the virtual server which belongs to the sample set.

The first feature amount storage unit 323 stores a correlation coefficient, as an example of an association amount, which is the first feature amount. Specifically, the first feature amount storage unit 323 stores a correlation coefficient table in which the correlation coefficient is set.

The first result storage unit 325 stores a result of first clustering. Specifically, the first result storage unit 325 stores a correlation cluster table in which an ID of a correlation cluster is set.

The second feature amount storage unit 327 stores resource usage for each time slot which is a second feature amount. Specifically, the second feature amount storage unit 327 stores a resource usage table (a CPU usage table, a disk usage table, and a network usage table) in which the resource usage for each resource is set for each time slot. Also, the time slot is a prescribed period from a start time to an end time in an arbitrary day.

The second result storage unit 329 stores a result of second clustering. Specifically, the second result storage unit 329 stores a time cluster table in which an ID of a time cluster (an ID of a CPU cluster, an ID of a disk cluster, and an ID of a network cluster) is set based on a temporal characteristic of the resource use.

The third result storage unit 331 stores a result of third clustering. Specifically, the third result storage unit 331 stores an integration cluster table in which an ID of an integration cluster is set based on the result of the first clustering and the result of the second clustering.

The above-described first acquisition unit 301, the first feature amount calculation unit 303, the first clustering unit 305, the first generation unit 307, the second feature amount calculation unit 309, the second clustering unit 311, the second generation unit 313, the third clustering unit 315, and the third generation unit 317 are realized using the hardware resources (for example, see FIG. 32) and the program that causes the processor to perform the process which will be described below.

The above-described first log storage unit 321, the first feature amount storage unit 323, the first result storage unit 325, the second feature amount storage unit 327, the second result storage unit 329, and the third result storage unit 331 are realized using the hardware resources (for example, see FIG. 32).

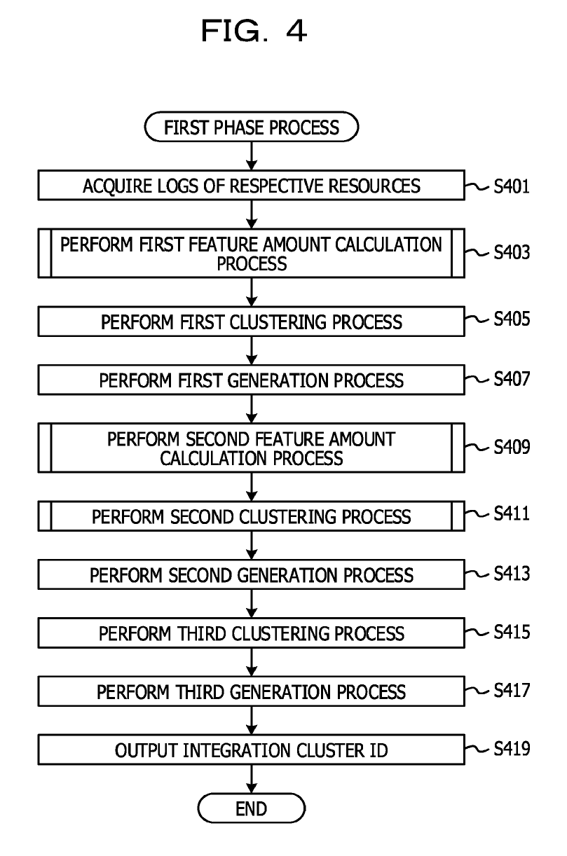

FIG. 4 illustrates a flow of the first phase process. In an example, the virtual servers correspond to a sample. Furthermore, it is assumed that the sample set is decided in advance. The first acquisition unit 301 acquires the logs of the respective resources in the virtual server which belongs to the sample set (S401). The first acquisition unit 301 acquires the logs from the virtual server or the management apparatus. In the example, it is assumed that the CPU, the disk, and the network correspond to the resources to be focused. Also, the first acquisition unit 301 may acquire a log of another resource (for example, a memory). For example, time-series CPU use rate is recorded in a log of the CPU. For example, time-series write data volume and read data volume are recorded in a log of the disk. For example, time-series transmission data volume and reception data volume are recorded in a log of the network.

The acquired logs are stored in the first log storage unit 321. In the example, the log of the CPU, the log of the disk, and the log of the network, which are related to a virtual server “server A”, are stored in the first log storage unit 321. Similarly, the log of the CPU, the log of the disk, and the log of the network, which are related to a virtual server “server B”, are stored in the first log storage unit 321. Similarly, the log of the CPU, the log of the disk, and the log of the network, which are related to a virtual server “server C”, are stored in the first log storage unit 321. Similarly, the log of the CPU, the log of the disk, and the log of the network, which are related to a virtual server “server D”, are stored in the first log storage unit 321. Similarly, the log of the CPU, the log of the disk, and the log of the network, which are related to a virtual server “server E”, are stored in the first log storage unit 321. Furthermore, the log of the CPU, the log of the disk, and the log of the network, which are related to a virtual server “server F” are stored in the first log storage unit 321.

The first feature amount calculation unit 303 performs the first feature amount calculation process (S403). In the first feature amount calculation process, a correlation coefficient of the resource use is calculated in relation to a combination of two resources. In the example, a correlation coefficient between a CPU use and a network use (mentioned as a CPU-network correlation coefficient), a correlation coefficient between the CPU use and a disk use (mentioned as a CPU-disk correlation coefficient), and a correlation coefficient between the disk use and the network use (mentioned as a disk-network correlation coefficient) are calculated.

For example, in a case of a virtual server which performs a batch process, both the CPU use and the network use are large while the batch process is performed. In addition, while the batch process is not performed, both the CPU use and the network use are small. Accordingly, the correlation coefficient between the CPU use and the network use becomes a large positive value.

Also, in a case where the memory is focused, the first feature amount calculation unit 303 may calculate a correlation coefficient between the memory use and the CPU use, a correlation coefficient between the memory use and a network use, and the correlation coefficient between the memory use and the disk use. The correlation coefficients are stored in the first feature amount storage unit 323 in the form of the correlation coefficient table which will be described below.

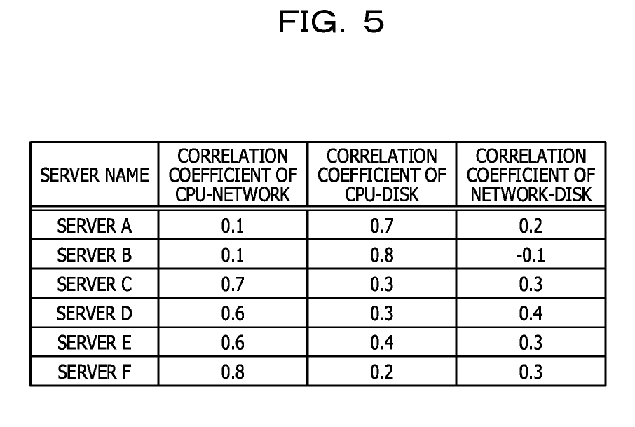

FIG. 5 illustrates an example of the correlation coefficient table. The correlation coefficient table in the example includes records corresponding to a virtual server of each sample. The records of the correlation coefficient table include a field in which a server name of the virtual server is set, a field in which the correlation coefficient between the CPU use and the network use is set, a field in which the correlation coefficient between the CPU use and the disk use is set, and a field in which the correlation coefficient between the disk use and the network use is set.

The example illustrates that the virtual server “server A” and the virtual server “server B” have a strong correlation related to the CPU use and the disk use. In addition, the example illustrates that the virtual server “server C” and the virtual server “server F” have a strong correlation related to the CPU use and the network use.

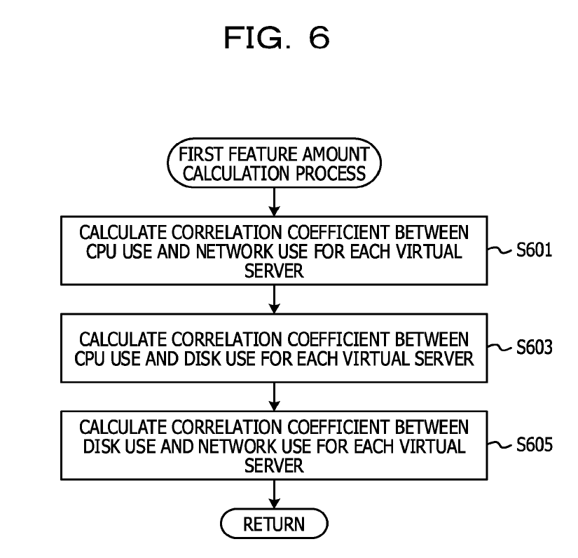

FIG. 6 illustrates a flow of the first feature amount calculation process. The first feature amount calculation unit 303 calculates the correlation coefficient between the CPU use and the network use based on the log of the CPU and the log of the network in each virtual server which belongs to the sample set (S601). A correlation analysis process of calculating the correlation coefficient is performed according to the related art.

Subsequently, the first feature amount calculation unit 303 calculates the correlation coefficient between the CPU use and the disk use based on the log of the CPU and the log of the disk for each virtual server which belongs to the sample set (S603).

Finally, the first feature amount calculation unit 303 calculates the correlation coefficient between the disk use and the network use based on the log of the disk and the log of the network for each virtual server which belongs to the sample set (S605). In a case where the first feature amount calculation process ends, the process returns to the calling first phase process.

Returning to description of FIG. 4. The first clustering unit 305 performs the first clustering process (S405). In the first clustering process, a cluster, to which the virtual server of each sample belongs, is generated using the respective correlation coefficients (in the example, the correlation coefficient between the CPU use and the network use, the correlation coefficient between the CPU use and the disk use, and the correlation coefficient between the disk use and the network use) as the feature amount. The result of the first clustering is stored in the first result storage unit 325 as the correlation cluster table. The clustering process is performed according to the related method such as Kmeans or Xmeans.

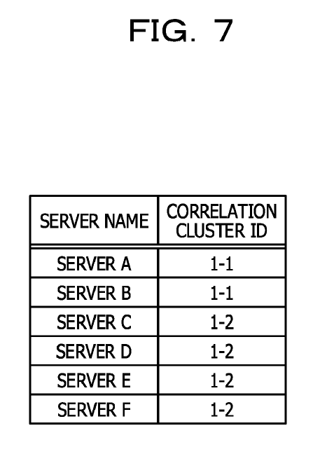

FIG. 7 illustrates an example of the correlation cluster table. The correlation cluster table in the example includes records corresponding to the virtual server of each sample. The records of the correlation cluster table include a field in which a server name of the virtual server is set, and a field in which an ID of the correlation cluster is set.

The example illustrates that the virtual server “server A” and the virtual server “server B” belong to a correlation cluster which has an ID “1-1”. In addition, the example illustrates that the virtual server “server C”, the virtual server “server D”, the virtual server “server E”, and the virtual server “server F” belong to a correlation cluster which has an ID “1-2”.

Returning to description of FIG. 4. The first generation unit 307 performs the first generation process (S407). In the first generation process, the first classification rule corresponding to a procedure of drawing a result, which is equivalent to or similar to the result of the first clustering, is generated. The first classification rule is stored in the first classification rule storage unit 203. In the example, a classification tree is generated by a classification tree analysis algorithm “C4.5”. The first generation unit 307 may generate a classification rule in another format.

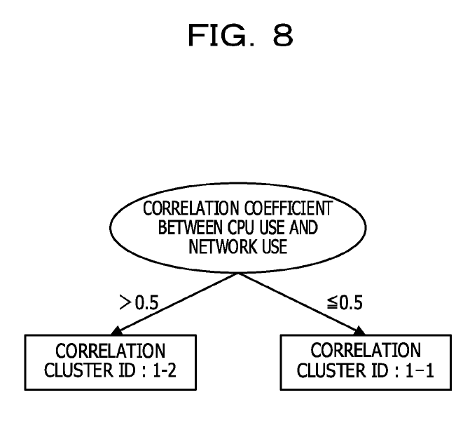

FIG. 8 illustrates an example of the first classification rule. A classification tree is configured to reach a node indicative of a result of classification by starting from a root and tracing a node which branches off according to judgment of condition in the format of IF-THEN. In the example, the judgment of condition in each node is performed by comparing a threshold with any one of the correlation coefficient between the CPU use and the network use, the correlation coefficient between the CPU use and the disk use, and the correlation coefficient between the disk use and the network use.

First, it is determined whether or not the correlation coefficient between the CPU use and the network use is equal to or less than 0.5. In a case where the correlation coefficient between the CPU use and the network use is equal to or less than 0.5, a virtual server which is the classification target belongs to the correlation cluster which has the ID “1-1”. In contrast, in a case where the correlation coefficient between the CPU use and the network use is larger than 0.5, the virtual server which is the classification target belongs to the correlation cluster which has the ID “1-2”.

Returning to description of FIG. 4. The second feature amount calculation unit 309 performs the second feature amount calculation process (S409). In the second feature amount calculation process, the second feature amount indicative of usage of each resource in each time slot is calculated. In the example, time slots, acquired by dividing one day by three hours, are assumed. In addition, in the example, the usage is a value which is normalized based on an average of total time slots.

For example, a CPU usage in a time slot from 0 am to 3 am is an average of the CPU use rate in the time slot from 0 am to 3 am/the CPU use rate in total time slots. Also, the CPU use rate in the time slot is a representative value (for example, an average value, a maximum value, or a central value) of the CPU use rate which is measured in the time slot.

For example, a disk usage in the time slot from 0 am to 3 am is an average of “disk I/O” in the time slot from 0 am to 3 am/“disk I/O” in the total time slots”. Also, the “disk I/O” in the time slot is the sum of write data volume and read data volume in the time slot.

For example, a network usage in the time slot from 0 am to 3 am is an average of “network I/O” in the time slot from 0 am to 3 am/“network I/O” in the total time slots. Also, the “network I/O” in the time slot is the sum of transmission data volume and reception data volume in the time slot.

However, the usage may be a value which is not normalized. That is, the usage may be expressed using a relative value, or the usage may be expressed by an absolute value. In addition, in a case where the memory is focused, a memory usage in each time slot may be calculated.

The CPU usage in each time slot is stored in the second feature amount storage unit 327 in the format of the CPU usage table which will be described below. The disk usage in each time slot is stored in the second feature amount storage unit 327 in the format of the disk usage table which will be described below. The network usage in each time slot is stored in the second feature amount storage unit 327 in the format of the network usage table which will be described below.

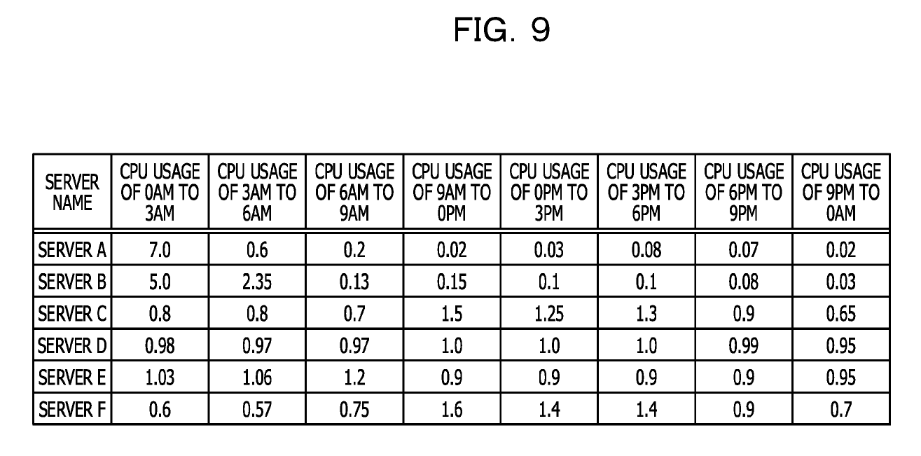

FIG. 9 illustrates an example of the CPU usage table. The CPU usage table in the example includes records corresponding to the virtual server of each sample. The records of the CPU usage table include a field in which a server name of the virtual server is set, and a field in which the CPU usage in each time slot is set.

The example illustrates that the virtual server “server A” and the virtual server “server B” have high CPU usage in a time slot corresponding to a part of the night. In addition, the virtual server “server C” and the virtual server “server F” have relatively high CPU usage in a time slot corresponding to daytime. Furthermore, the virtual server “server D” and the virtual server “server E” have stable CPU usage throughout the day.

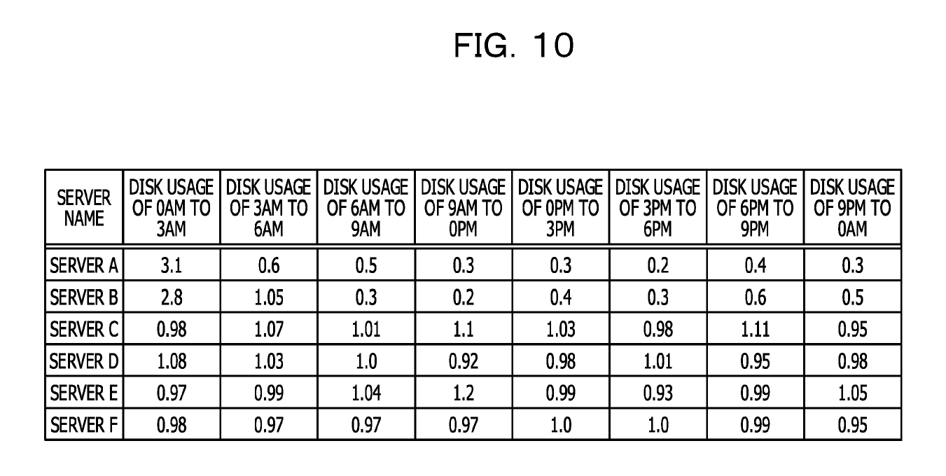

FIG. 10 illustrates an example of the disk usage table. The disk usage table in the example includes records corresponding to the virtual server of each sample. The records of the disk usage table include a field in which a server name of the virtual server is set, and a field in which the disk usage in each time slot is set.

The example illustrates that the virtual server “server A” and the virtual server “server B” have high disk usage in the time slot corresponding to a part of the night. In addition, the virtual server “server C”, the virtual server “server D”, the virtual server “server E”, and the virtual server “server F” have stable disk usage throughout the day.

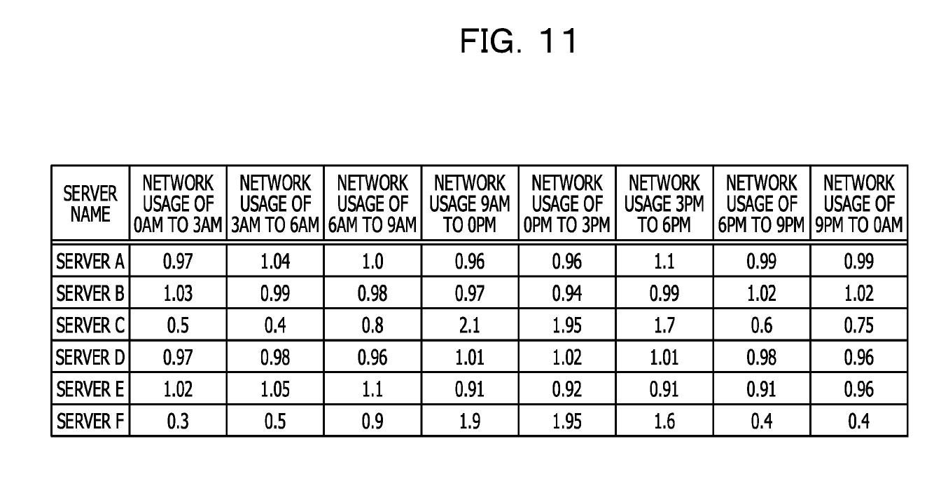

FIG. 11 illustrates an example of the network usage table. The network usage table in the example includes records corresponding to the virtual server of each sample. The records of the network usage table include a field in which a server name of the virtual server is set, and a field in which the network usage in each time slot is set.

The example illustrates that the virtual server “server A”, the virtual server “server B”, the virtual server “server D”, and the virtual server “server E” have stable network usage throughout the day. In addition, the example illustrates that the virtual server “server C” and the virtual server “server F” have relatively high network usage in the time slot corresponding to daytime.

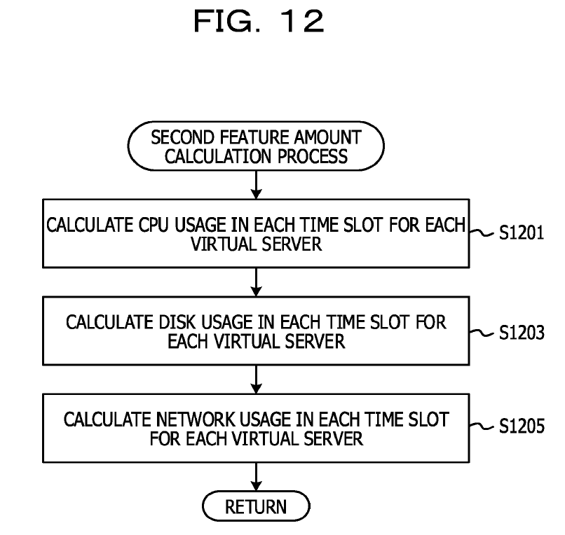

FIG. 12 illustrates a flow of the second feature amount calculation process. The second feature amount calculation unit 309 calculates the CPU usage in each time slot based on the log of the CPU for each virtual server which belongs to the sample set (S1201). Specifically, the second feature amount calculation unit 309 performs a process below for each virtual server. The second feature amount calculation unit 309 first specifies a representative value (for example an average value, a maximum value, or a central value) of the CPU use rate which is measured in each time slot. Subsequently, the second feature amount calculation unit 309 acquires an average of the representative value. Furthermore, the second feature amount calculation unit 309 calculates a quotient (CPU usage in the time slot) by dividing the representative value of the time slot by the average of the representative value in each time slot.

The second feature amount calculation unit 309 calculates the disk usage in each time slot set based on the log of the disk for each virtual server which belongs to the sample set (S1203). Specifically, the second feature amount calculation unit 309 performs a process illustrated below on each virtual server. The second feature amount calculation unit 309 first acquires the sum of the write data volume and the read data volume in each time slot. Subsequently, the second feature amount calculation unit 309 acquires an average of the sum. Furthermore, the second feature amount calculation unit 309 calculates a quotient (disk usage in the time slot) by dividing the sum of the time slots by the average of the sum in each time slot.

The second feature amount calculation unit 309 calculates the network usage in each time slot based on the log of the network for each virtual server which belongs to the sample set (S1205). Specifically, the second feature amount calculation unit 309 performs a process illustrated below on each virtual server. The second feature amount calculation unit 309 first acquires the sum of the transmission data volume and the reception data volume in each time slot. Subsequently, the second feature amount calculation unit 309 acquires an average of the sum. Furthermore, the second feature amount calculation unit 309 calculates a quotient (network usage in the time slot) by dividing the sum of the time slot for each time slots by the average of the sum. In a case where the second feature amount calculation process ends, the process returns to the calling first phase process.

Returning to description of FIG. 4. The second clustering unit 311 performs the second clustering process (S411). In the second clustering process, the resource usage in each time slot is set to the feature amount for each resource, and a cluster to which the virtual server of each sample belongs is generated. The clustering process is performed using a method according to the related art such as Kmeans or Xmeans.

A cluster generated by the second clustering based on the temporal characteristic of the resource use is referred to as the time cluster. In the example, a CPU cluster based on a temporal characteristic of the CPU use, a disk cluster based on a temporal characteristic of the disk use, and a network cluster based on a temporal characteristic of the network use correspond to the time cluster. Furthermore, the result of the second clustering is stored in the second result storage unit 329 as the time cluster table.

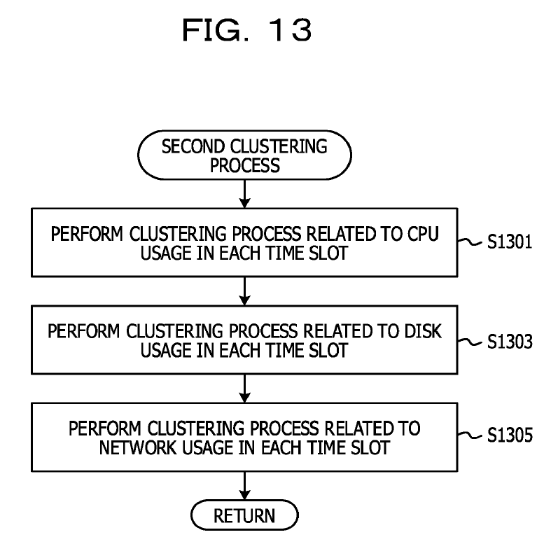

FIG. 13 illustrates a flow of the second clustering process. The second clustering unit 311 first performs a clustering process related to the CPU usage in each time slot (S1301). That is, the second clustering unit 311 generates a cluster (CPU cluster), to which the virtual servers of the sample belong, using the CPU usage in each time slot as the feature amount. Furthermore, an ID of the CPU cluster, to which the respective virtual servers of the sample belong, is set in the time cluster table.

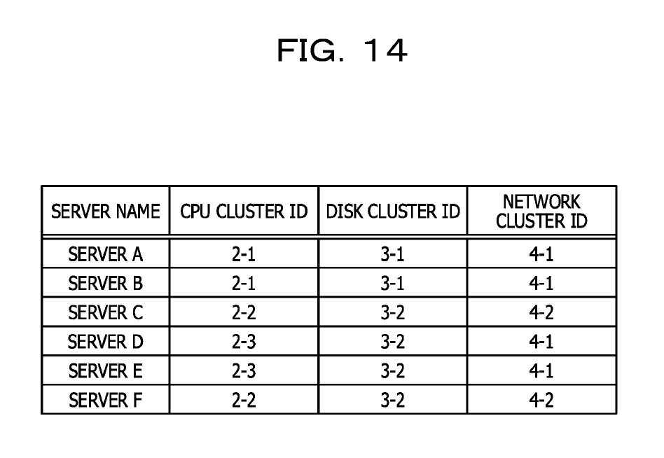

FIG. 14 illustrates an example of the time cluster table. The time cluster table in the example includes records corresponding to the virtual server of each sample. The records of the time cluster table include a field in which a server name of the virtual server is set, a field in which an ID of the CPU cluster is set, a field in which an ID of a disk cluster is set, and a field in which an ID of a network cluster is set.

For example, a first record indicates that the virtual server “server A” belongs to a CPU cluster having an ID “2-1”, belongs to a disk cluster having an ID “3-1”, and, further, belongs to a network cluster having an ID “4-1”.

Returning to description of FIG. 13. The second clustering unit 311 subsequently performs a clustering process related to disk usage in each time slot (S1303). That is, the second clustering unit 311 generates a cluster (disk cluster), to which the virtual servers of the sample belong, using the disk usage in each time slot as the feature amount. Furthermore, an ID of a disk cluster, to which the respective virtual servers of the sample belong, is set in the time cluster table.

The second clustering unit 311 finally performs a clustering process related to the network usage in each time slot (S1305). That is, the second clustering unit 311 generates a cluster (network cluster), to which the virtual servers of the sample belongs, using the network usage in the time slot as the feature amount. Furthermore, an ID of a network cluster, to which the respective virtual servers of the sample belong, is set in the time cluster table. In a case where the second clustering process ends, the process returns to the calling first phase process.

Returning to description of FIG. 4. The second generation unit 313 performs the second generation process (S413). In the second generation process, the second classification rule corresponding to a procedure of drawing a result, which is equivalent to or similar to the result of the second clustering, is generated for each resource. The second classification rule is stored in the second classification rule storage unit 205. In the example, a classification tree is generated by the classification tree analysis algorithm “C4.5”. The second generation unit 313 may generate the classification rule in another form.

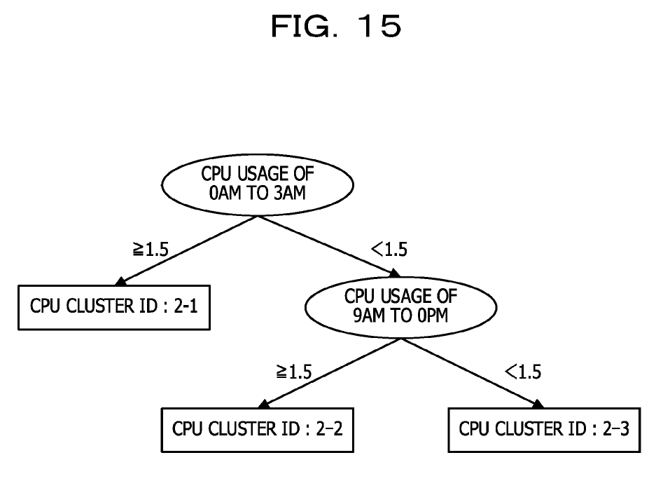

FIG. 15 illustrates an example of the second classification rule related to the CPU usage. The second classification rule in the example is a classification tree similarly to the first classification rule. The second classification rule illustrated in FIG. 15 is a rule for classifying the virtual servers based on the temporal characteristic of the CPU usage. The conditional judgment in each node is performed by comparing the CPU usage in any one of time slots with a threshold.

In the example, first, it is determined whether or not the CPU usage in the time slot from 0 am to 3 am is equal to or larger than 1.5. In a case where the CPU usage in the time slot from 0 am to 3 am is equal to or larger than 1.5, the virtual server which is the classification target belongs to the CPU cluster having the ID “2-1”. In contrast, in a case where the CPU usage in the time slot from 0 am to 3 am is smaller than 1.5, it is determined whether or not the CPU usage in the time slot from 9 am to 0 pm is equal to or larger than 1.5.

In a case where the CPU usage in the time slot from 9 am to 0 pm is equal to or larger than 1.5, the virtual server which is the classification target belongs to a CPU cluster having an ID “2-2”. In contrast, in a case where the CPU usage in the time slot from 9 am to 0 pm is smaller than 1.5, the virtual server which is the classification target belongs to a CPU cluster having an ID “2-3”.

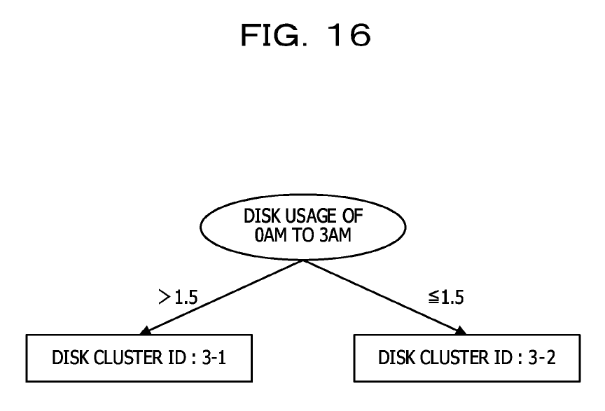

FIG. 16 illustrates an example of the second classification rule related to the disk usage. The second classification rule illustrated in FIG. 16 is a rule for classifying the virtual servers based on the temporal characteristic of the disk usage. The conditional judgment in each node is performed by comparing the disk usage in any one of time slots with a threshold.

In the example, it is determined whether or not the disk usage in the time slot from 0 am to 3 am is larger than 1.5. In a case where the disk usage in the time slot from 0 am to 3 am is larger than 1.5, the virtual server which is the classification target belongs to a disk cluster having an ID “3-1”. In contrast, in a case where the disk usage in the time slot from 0 am to 3 am is equal to or lower than 1.5, the virtual server which is the classification target belongs to a disk cluster having an ID “3-2”.

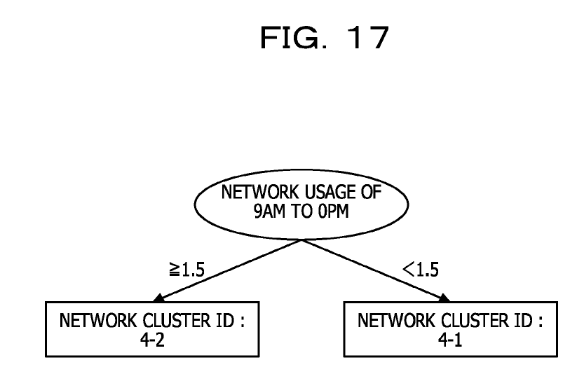

FIG. 17 illustrates an example of the second classification rule related to the network usage. The second classification rule illustrated in FIG. 17 is a rule for classifying the virtual servers based on the temporal characteristic of the network usage. The conditional judgment in each node is performed by comparing the network usage in any one of time slots with a threshold.

In the example, it is determined whether or not the network usage in the time slot from 9 am to 0 pm is smaller than 1.5. In a case where the network usage in the time slot from 9 am to 0 pm is smaller than 1.5, the virtual server which is the classification target belongs to a network cluster having an ID “4-1”. In contrast, the network usage in the time slot from 9 am to 0 pm is equal to or larger than 1.5, the virtual server which is the classification target belongs to a network cluster having an ID “4-2”.

Returning to description of FIG. 4. The third clustering unit 315 performs the third clustering process (S415). In the third clustering process, a cluster, to which the virtual servers of the sample belongs, is generated using an ID of a correlation cluster, IDs of respective time clusters (in the example, the ID of the CPU cluster, the ID of the disk cluster, and the ID of the network cluster) as attributes. The clustering process is performed using the method according to the related art such as Kmeans or Xmeans. Furthermore, the IDs of the integration clusters, to which the respective virtual servers of the sample belong, are set in the integration cluster table.

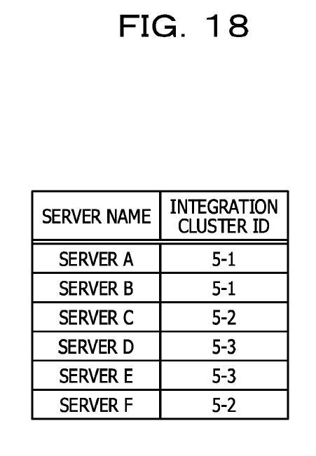

FIG. 18 illustrates an example of the integration cluster table. The integration cluster table in the example includes records corresponding to the virtual server of each sample. The records of the integration cluster table include a field in which a server name of the virtual server is set, and a field in which an ID of the integration cluster is set.

The example illustrates that the virtual server “server A” and the virtual server “server B” belong to the integration cluster (ID: “5-1”). That is, the virtual server “server A” and the virtual server “server B” have the same or a similar characteristic related to the resource use.

In addition, the example illustrates that the virtual server “server C” and the virtual server “server F” belong to the same integration cluster (ID: “5-2”). That is, the virtual server “server C” and the virtual server “server F” include the same or a similar characteristic related to the resource use.

Furthermore, the example illustrates that the virtual server “server D” and the virtual server “server E” belong to the same integration cluster (ID: “5-3”). That is, the virtual server “server D” and the virtual server “server E” have the same or a similar characteristic related to the resource use.

Returning to description of FIG. 4. The third generation unit 317 performs the third generation process (S417). In the third generation process, the third classification rule corresponding to a procedure of drawing a result, which is equivalent to or similar to the result of the third clustering, is generated. The third classification rule is stored in the third classification rule storage unit 207. In the example, a classification tree is generated by the classification tree analysis algorithm “C4.5”. The second generation unit 313 may generate the classification rule in another form.

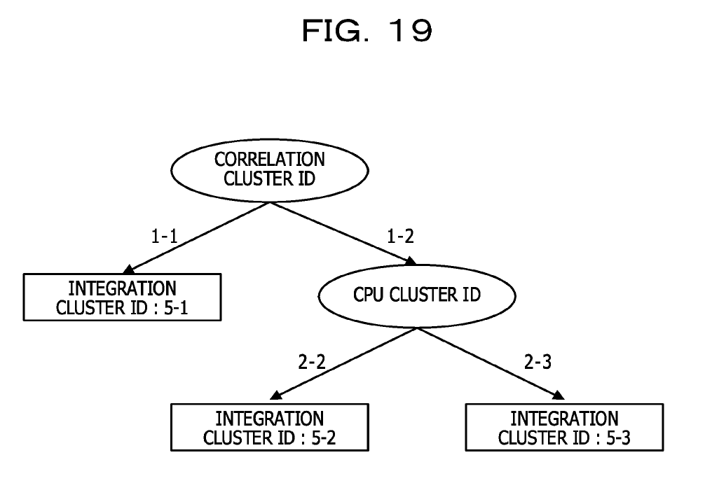

FIG. 19 illustrates an example of the third classification rule. The third classification rule is a rule for classifying the virtual server based on the ID of the correlation cluster, the ID of the CPU cluster, the ID of the disk cluster, and the ID of the network cluster, to which the virtual server which is the classification target belongs. The conditional judgment performed on each node relates to the ID of the correlation cluster, the ID of the CPU cluster, the ID of the disk cluster, and the ID of the network cluster.

In the example, first, it is determined whether the ID of the correlation cluster is “1-1” or “1-2”. In a case where the ID of the correlation cluster is “1-1”, the virtual server which is the classification target belongs to an integration cluster having an ID “5-1”. In contrast, in a case where the ID of the correlation cluster is “1-2”, it is determined whether the ID of the CPU cluster is “2-2” or “2-3”.

In a case where the ID of the CPU cluster is “2-2”, the virtual server which is the classification target belongs to an integration cluster having an ID “5-2”. In contrast, in a case where the ID of the CPU cluster is “2-3”, the virtual server which is the classification target belongs to an integration cluster having an ID “5-3”.

In the example, the ID “5-1” of the integration cluster corresponds to a type of a virtual server which performs a batch process of writing data into a disk at night. The ID “5-2” of the integration cluster corresponds to a type of a virtual server which provides an on-line service in the daytime. The ID “5-3” of the integration cluster corresponds to a type of a virtual server which provides the on-line service all day. As described above, in a case where the type of the virtual server is specified, the ID of the integration cluster may be associated with a type name (for example, a “batch process type”, a “daytime on-line type”, and “all day on-line type”).

Returning to description of FIG. 4. Finally, the output unit 211 outputs the ID of the integration cluster to which the virtual server of each sample belongs (S419). The output unit 211 may output a type name corresponding to the ID of the integration cluster. In addition, the output unit 211 may output the ID of the correlation cluster and the ID of the time cluster. Furthermore, the first phase process ends.

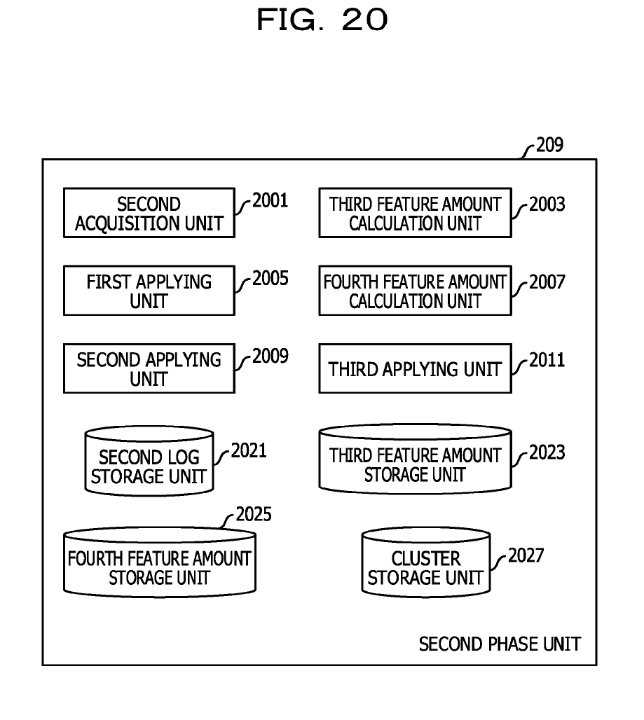

Subsequently, the second phase process will be described. FIG. 20 illustrates an example of a configuration of modules of the second phase unit 209. The second phase unit 209 includes a second acquisition unit 2001, a third feature amount calculation unit 2003, a first applying unit 2005, a fourth feature amount calculation unit 2007, a second applying unit 2009, a third applying unit 2011, a second log storage unit 2021, a third feature amount storage unit 2023, a fourth feature amount storage unit 2025, and a cluster storage unit 2027.

The second acquisition unit 2001 acquires a log of each resource in the virtual server which is the classification target. The third feature amount calculation unit 2003 performs a third feature amount calculation process. The first applying unit 2005 performs a first application process. The fourth feature amount calculation unit 2007 performs a fourth feature amount calculation process. The second applying unit 2009 performs a second application process.

The third applying unit 2011 performs a third application process. Also, the third feature amount calculation process, the fourth feature amount calculation process, the first application process, the second application process, and the third application process will be described below.

The second log storage unit 2021 stores the log of each resource in the virtual server which is the classification target.

The third feature amount storage unit 2023 stores a correlation coefficient which is the third feature amount. Specifically, the third feature amount storage unit 2023 stores a correlation coefficient table in which the correlation coefficient is set.

The fourth feature amount storage unit 2025 stores time-based resource usage which is a fourth feature amount. Specifically, the fourth feature amount storage unit 2025 stores a resource usage tables (in the example, a CPU usage table, a disk usage table, and a network usage table) in which resource usage is set for each resource in each time slot.

The cluster storage unit 2027 stores an ID of a cluster to which the virtual server which is the classification target belongs. Specifically, the cluster storage unit 2027 stores the cluster table. The cluster table will be described later.

The above-described second acquisition unit 2001, the third feature amount calculation unit 2003, the first applying unit 2005, the fourth feature amount calculation unit 2007, the second applying unit 2009, and the third applying unit 2011 are realized using the hardware resources (for example, see FIG. 32) and a program which causes a processor to perform a process which will be described later.

The above-described second log storage unit 2021, the third feature amount storage unit 2023, the fourth feature amount storage unit 2025, and the cluster storage unit 2027 are realized using the hardware resources (for example, see FIG. 32).

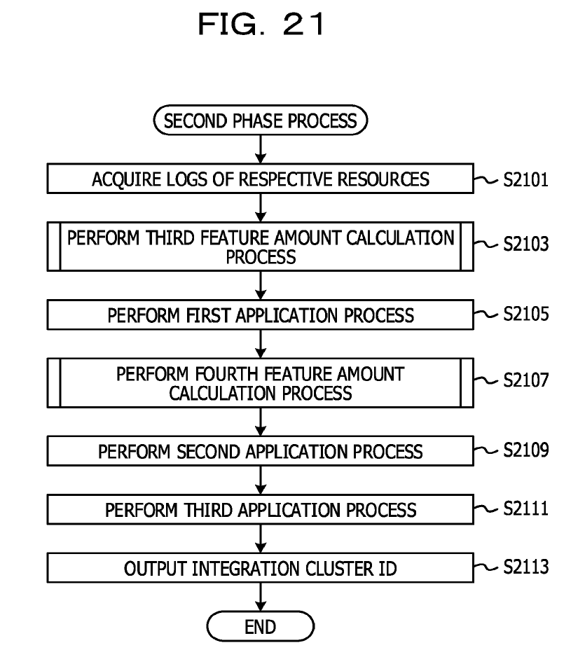

FIG. 21 illustrates a flow of the second phase process. The second acquisition unit 2001 acquires a log of each resource in the virtual server which is the classification target (S2101). The second acquisition unit 2001 acquires the log from the virtual server or the management apparatus. The acquired log is stored in the second log storage unit 2021.

The third feature amount calculation unit 2003 performs the third feature amount calculation process (S2103). In the third feature amount calculation process, a correlation coefficient is calculated in relation to a combination of two resources, similarly to the case of the first feature amount calculation process. In the example, a correlation coefficient between the CPU use and the network use, a correlation coefficient between the CPU use and the disk use, and a correlation coefficient between the disk use and the network use are calculated.

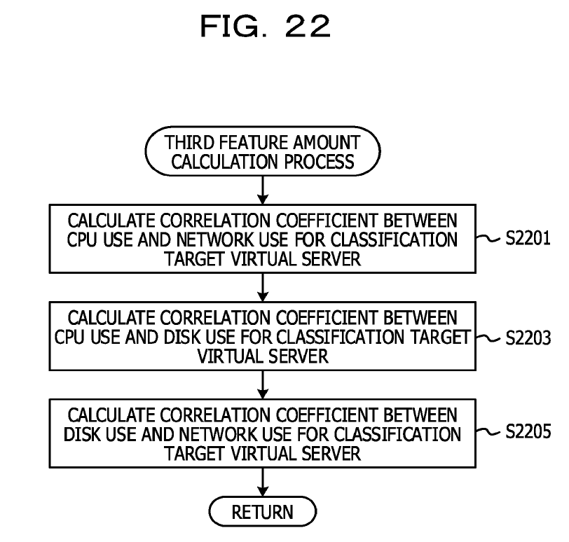

FIG. 22 illustrates a flow of the third feature amount calculation process. The third feature amount calculation unit 2003 calculates the correlation coefficient between the CPU use and the network use based on the log of the CPU and the log of the network for the virtual server which is the classification target (S2201). A correlation analysis process of calculating the correlation coefficient is performed according to the related art.

Subsequently, the third feature amount calculation unit 2003 calculates the correlation coefficient between the CPU use and the disk use based on the log of the CPU and the log of the disk for the virtual server which is the classification target (S2203).

Finally, the third feature amount calculation unit 2003 calculates the correlation coefficient between the disk use and the network use based on the log of the disk and the log of the network for the virtual server which is the classification target (S2205).

In a case where a memory is focused, the third feature amount calculation unit 2003 may calculate a correlation coefficient between the memory use and the CPU use, a correlation coefficient between the memory use and the network use, and a correlation coefficient between the memory use and the disk use. The correlation coefficient is stored in the third feature amount storage unit 2023 using a correlation coefficient table format which will be described below.

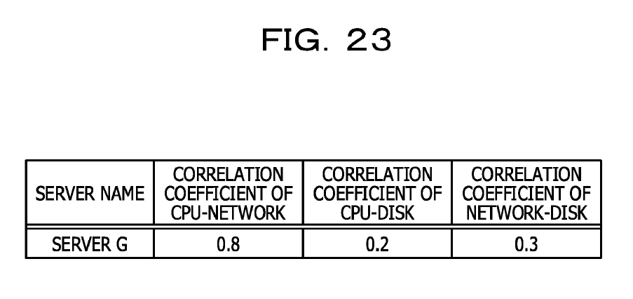

FIG. 23 illustrates an example of the correlation coefficient table. The correlation coefficient table in the example has records corresponding to the virtual server which is the classification target. The records of the correlation coefficient table include a field in which a server name of the virtual server is set, a field in which the correlation coefficient between the CPU use and the network use is set, a field in which the correlation coefficient between the CPU use and the disk use, and a field in which the correlation coefficient between the disk use and the network use are set. There may be provided a plurality of virtual servers corresponding to the classification target.

The example illustrates that there is a strong correlation related to the CPU use and the network use for the virtual server “server G” which is the classification target.

Returning to the description of FIG. 22. In a case where the third feature amount calculation process ends, the process returns to the calling second phase process.

Returning to the description of FIG. 21. The first applying unit 2005 performs the first application process (S2105). In the first application process, the virtual server which is the classification target is classified by applying each correlation coefficient, which is the third feature amount, to the first classification rule. Specifically, the first applying unit 2005 determines whether or not the virtual server which is the classification target belongs to any one of the correlation clusters. An ID of the determined correlation cluster is set in the cluster table.

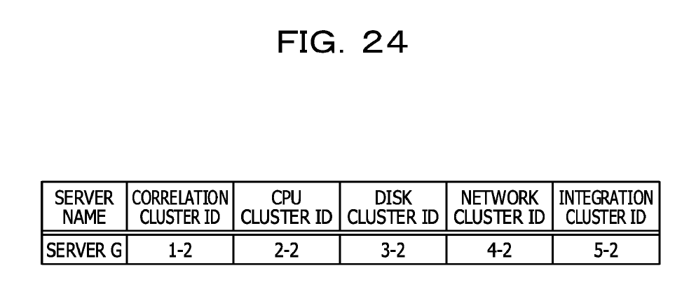

FIG. 24 illustrates the cluster table. The cluster table in the example has records corresponding to the virtual server which is the classification target. The records of the cluster table include a field in which a server name of the virtual server is set, a field in which the ID of the correlation cluster is set, a field in which the ID of each time cluster (in the example, an ID of the CPU cluster, a ID of the disk cluster, and an ID of the network cluster) is set, and a field in which an ID of the integration cluster is set.

FIG. 24 illustrates a state of a phase after the first to third application processes end. It is illustrated that the virtual server “server G”, which is the classification target, belongs to a correlation cluster having the ID “1-2”, a CPU cluster having the ID “2-2”, a disk cluster having an ID “3-2”, and a network cluster having the ID “4-2”. Furthermore, it is illustrated that the virtual server “server G” which is the classification target is finally classified as an integration cluster having the ID “5-2”.

Returning to the description of FIG. 21. The fourth feature amount calculation unit 2007 performs the fourth feature amount calculation process (S2107). In the fourth feature amount calculation process, a fourth feature amount, which indicates usage of each resource in each time slot, is calculated, similarly to the case of the second feature amount calculation process. In addition, the usage in the example is a normalized value, similarly to the case of the second feature amount calculation process.

The CPU usage in each time slot is stored in the fourth feature amount storage unit 2025, in the format of the CPU usage table. The disk usage in each time slot is stored in the fourth feature amount storage unit 2025 in the format of the disk usage table. The network usage in each time slot is stored in the fourth feature amount storage unit 2025 in the format of the network usage table.

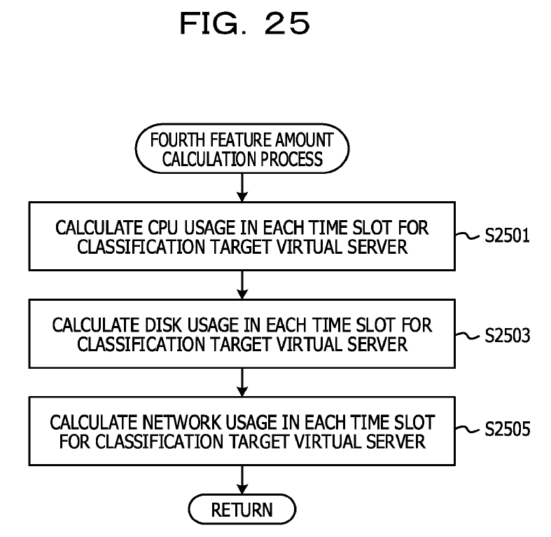

FIG. 25 illustrates a flow of the fourth feature amount calculation process. The fourth feature amount calculation unit 2007 calculates the CPU usage in each time slot for the virtual server which is the classification target (S2501). A procedure of calculating the CPU usage in each time slot is similar to the case of the second feature amount calculation process.

Subsequently, the fourth feature amount calculation unit 2007 calculates the disk usage in each time slot for the virtual server which is the classification target (S2503). A procedure of calculating the disk usage in each time slot is similar to the case of the second feature amount calculation process.

Finally, the fourth feature amount calculation unit 2007 calculates the network usage in each time slot for the virtual server which is the classification target (S2505). A procedure of calculating the network usage in each time slot is similar to a case of the second feature amount calculation process. In a case where the fourth feature amount calculation process ends, the process returns to the calling second phase process.

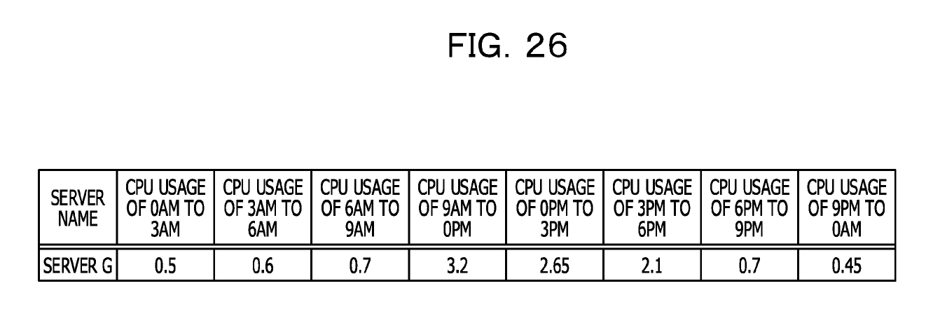

FIG. 26 illustrates an example of the CPU usage table in the second phase. The CPU usage table in the second phase has records corresponding to the virtual server which is the classification target. The records of the CPU usage table include a field in which a server name of the virtual server is set, and a field in which the CPU usage in each time slot is set.

The example illustrates that the CPU usage in the time slot corresponding to daytime is relatively high in the virtual server “server G” which is the classification target.

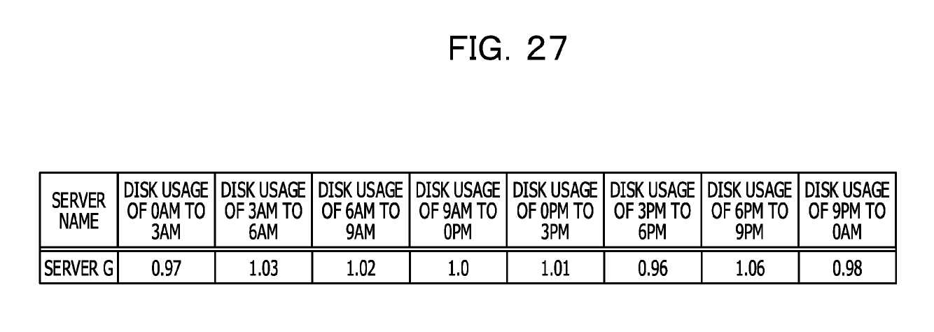

FIG. 27 illustrates an example of the disk usage table in the second phase. The disk usage table in the second phase includes records corresponding to the virtual server which is the classification target. The records of the disk usage table include a field in which a server name of the virtual server is set, and a field in which the disk usage in each time slot is set.

The example illustrates that the disk usage is stable throughout the day in the virtual server “server G” which is the classification target.

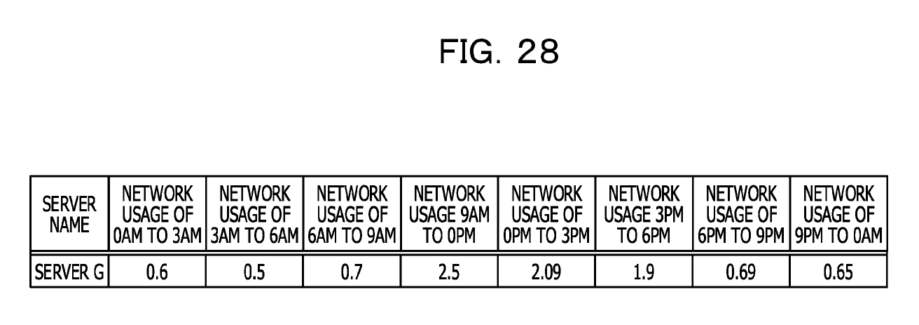

FIG. 28 illustrates an example of the network usage table in the second phase. The network usage table in the second phase includes records corresponding to the virtual server which is the classification target. The records of the network usage table include a field in which a server name of the virtual server is set, and a field in which the network usage in each time slot is set.

The example illustrates that the network usage is relatively high in the time slot corresponding to daytime in the virtual server “server G” which is the classification target.

Returning to the description of FIG. 21. The second applying unit 2009 performs the second application process (S2109). In the second application process, the virtual server, which is the classification target, is classified by applying each resource usage which is the fourth feature amount to the second classification rule. Specifically, the first applying unit 2005 identifies a CPU cluster to which the virtual server, which is the classification target, belongs. In addition, the first applying unit 2005 identifies a disk cluster to which the virtual server, which is the classification target, belongs. Furthermore, the first applying unit 2005 identifies a network cluster to which the virtual server, which is the classification target, belongs. The respective IDs of the determined CPU cluster, the disk cluster, and the network cluster are set in the cluster table.

Subsequently, the third applying unit 2011 performs the third application process (S2111). In the third application process, the virtual server which is the classification target is classified by applying an ID of a correlation cluster, an ID of a CPU cluster, an ID of a disk cluster, and an ID of a network cluster, to which the virtual server which is the classification target belongs, to the third classification rule. Specifically, the third applying unit 2011 determines an integration cluster to which the virtual server, which is the classification target, belongs.

In the example, in a case where the ID of the correlation cluster “1-2” and the ID of the CPU cluster “2-2”, which are illustrated in FIG. 24, are applied to the third classification rule illustrated in FIG. 19, it is determined that the virtual server “server G” which is the classification target belongs to an integration cluster having the ID “5-2”. Furthermore, the ID of the determined integration cluster is set in the cluster table.

The output unit 211 outputs the ID of the integration cluster corresponding to the virtual server which is the classification target (S2113). The output unit 211 may output a type name corresponding to the ID of the integration cluster. In addition, the output unit 211 may output the ID of the correlation cluster and the ID of the time cluster.

Here, utilization of a result of the classification according to the embodiment in optimization of resource distribution will be described. In a case of a virtual server that performs a process (for example, the batch process) of simultaneously using a plurality of resources with high frequency, the virtual server may not operate as expected even though sufficient permissible usage related to only one resource is secured.

In addition, it is inefficient in a case where large permissible usage related to the resource is secured all the time in relation to a virtual server (for example, a server which provides an on-line service in daytime) which performs a process of using a specific resource with high frequency only in a specific time slot.

However, according to the embodiment, the virtual server is classified based on the correlation characteristic and the temporal characteristic of the resource use. In a case where assignment of the resource is controlled with reference to a result of the classification, the above-described problems are easily solved. That is, in a case where the type of the virtual server is estimated based on the result of the classification, each virtual server is smoothly operated, thereby being helpful to effectively use the resource.

As described above, according to the embodiment, it is possible to generate an apparatus classification rule, which is further suitable to classification in which the characteristic of the resource use is focused, by generating the first phase process.

Specifically, it is possible to generate a rule for classifying the virtual server by combining the correlation characteristic of the resource use with the temporal characteristic of each resource use through the combination.

In addition, it is possible to more correctly classify the virtual server in relation to the characteristic of the resource use through the second phase process.

### Embodiment 2

In an embodiment, a form, in which a second phase process is performed in a classification apparatus 103 that is separate from the classification apparatus 103 which performs the first phase process, will be described.

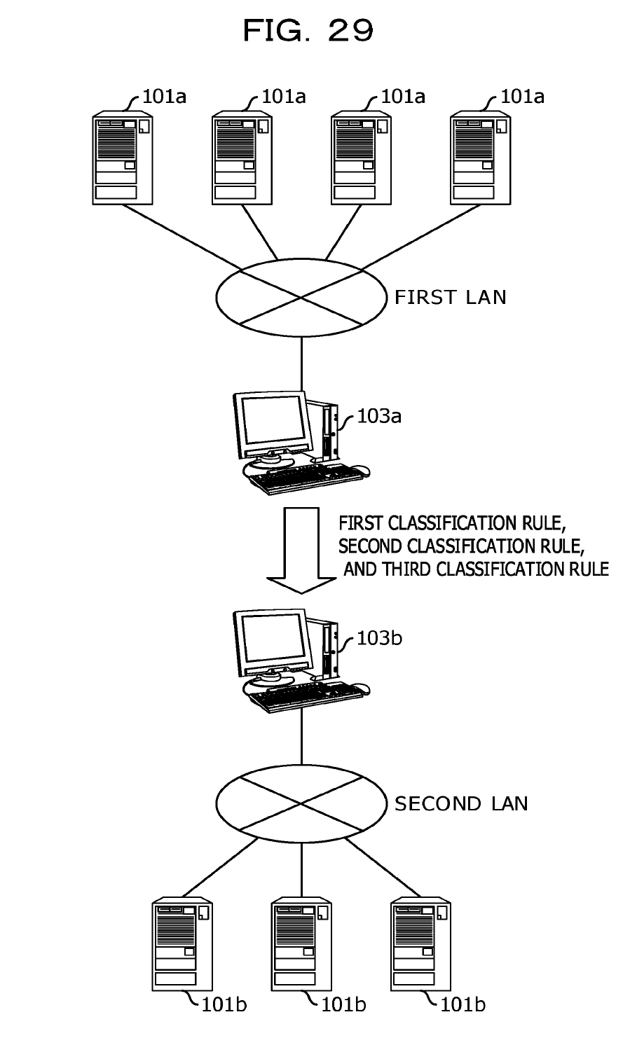

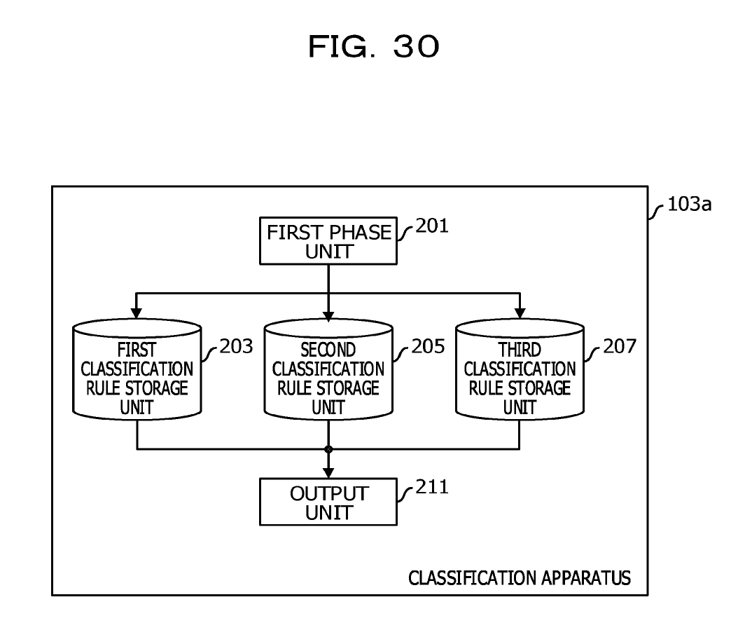

FIG. 29 illustrates an example of a configuration of a network according to Embodiment 2. A classification apparatus 103a, which is coupled to a first LAN, performs a first phase process. As illustrated in FIG. 30, the classification apparatus 103a includes a first phase unit 201, a first classification rule storage unit 203, a second classification rule storage unit 205, a third classification rule storage unit 207, and an output unit 211.

The first phase unit 201 of the classification apparatus 103a performs a first phase process while using a virtual server, which is deployed in a physical server 101a of the first LAN, as a sample. A first classification rule, which is generated in the first phase process, is stored in the first classification rule storage unit 203. A second classification rule, which is generated in the first phase process, is stored in the second classification rule storage unit 205. A third classification rule, which is generated in the first phase process, is stored in the third classification rule storage unit 207.

Furthermore, the output unit 211 of the classification apparatus 103a outputs the first classification rule, the second classification rule, and the third classification rule which are generated in the first phase process. A form of the output includes, for example, transmission to a network or recording in a storage medium.

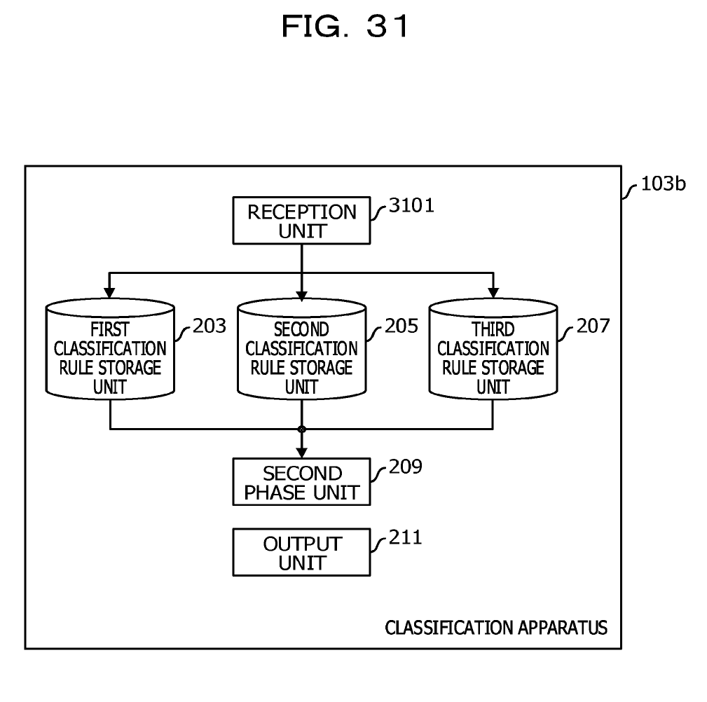

A classification apparatus 103b, which is coupled to a second LAN, performs the second phase process. As illustrated in FIG. 31, the classification apparatus 103b includes a reception unit 3101, a first classification rule storage unit 203, a second classification rule storage unit 205, a third classification rule storage unit 207, a second phase unit 209, and an output unit 211.

The reception unit 3101 receives the first classification rule, the second classification rule, and the third classification rule. A form of the reception includes, for example, reception from the network or reading from the storage medium. The first classification rule is stored in the first classification rule storage unit 203. The second classification rule is stored in the second classification rule storage unit 205. The third classification rule is stored in the third classification rule storage unit 207.

The second phase unit 209 of the classification apparatus 103b performs the second phase process while using the virtual server, which is deployed in the physical server 101b, as a classification target according to the first classification rule, the second classification rule, and the third classification rule. Furthermore, the output unit 211 outputs a cluster of the virtual server which is deployed in the physical server 101b.

According to the embodiment, it is easy to apply a rule for classifying an apparatus in relation to the characteristic of the resource use.

In the examples of Embodiments 1 and 2, an example in which the virtual server becomes the classification target is described. However, classification may be performed on a physical server apparatus. In addition, a virtual information processing apparatus other than the server may become the classification target. Furthermore, a physical information processing apparatus other than the server may become the classification target.

Although the embodiments have been described above, the embodiment is not limited thereto. For example, there is a case where the above-described functional block configuration does not coincide with a program module configuration.

In addition, the above-described configuration of each storage area is an example, and the embodiments may not be limited to the above-described configuration. Furthermore, in the flow of the process, as far as a result of the process is not changed, the sequence of the process may be replaced or a plurality of processes may be performed in parallel.

Meanwhile, the above-described classification apparatus 103 is a computer apparatus. As illustrated in FIG. 32, a memory 2501, a central processing unit (CPU) 2503, a hard disk drive (HDD) 2505, a display control unit 2507 which is coupled to a display apparatus 2509, a drive apparatus 2513 for a removable disk 2511, an input apparatus 2515, and a communication control unit 2517 which is coupled to a network are coupled to each other through a bus 2519. An operating system (OS) and an application program, which performs a process in the embodiment, are stored in the HDD 2505. In a case where the OS and the application program are performed by the CPU 2503, the OS and the application program are read from the HDD 2505 into the memory 2501. The CPU 2503 controls the display control unit 2507, the communication control unit 2517, and the drive apparatus 2513 according to content of the process of the application program, and performs a prescribed operation. In addition, although data which is being processed is mainly stored in the memory 2501, the data may be stored in the HDD 2505. In the embodiments, the application program, which causes the above-described process to be performed, is stored and distributed in a computer-readable removable disk 2511, and is installed in the HDD 2505 from the drive apparatus 2513. There is a case where the application program is installed in the HDD 2505 through the network, such as the Internet, and the communication control unit 2517. The computer apparatus realizes the above-described various functions through organic cooperation of the above-described CPU 2503, the hardware, such as the memory 2501, and a program, such as the OS and the application program.

The above-described embodiments are summarized as below.

A generation method according to the embodiment includes (A) calculating, for each of a plurality of apparatuses, a first feature amount that indicates a correlation between resource uses according to a combination of resources which are used by the apparatus based on first logs related to the plurality of resources which are respectively used by the plurality of apparatuses; (B) performing first clustering on the plurality of apparatuses based on the first feature amount; (C) generating a first apparatus classification rule based on a first result of the first clustering; (D) calculating a second feature amount that indicates a resource usage in each time slot for each of the resources which are respectively used by the plurality of apparatuses based on the first logs; (E) performing second clustering on the plurality of apparatuses based on the second feature amount; (F) generating a second apparatus classification rule based on a second result of the second clustering; (G) performing third clustering on the plurality of apparatuses based on the first result of the first clustering and the second result of the second clustering; and (H) generating a third apparatus classification rule based on a third result of the third clustering.

In this manner, it is possible to generate an apparatus classification rule which is more suitable for classification focused on a characteristic of the resource use. Specifically, it is possible to generate a rule for classifying an apparatus by combining the correlation characteristic of the resource use and the temporal characteristic of each resource use according to the combination.

Furthermore, in the third clustering, first cluster identification information according to the first clustering and second cluster identification information according to the second clustering may be used as attributes, and the third apparatus classification rule may include at least one of the first cluster identification information and the second cluster identification information as a judgment condition parameter.

In this manner, it is easy to classify the apparatus by combining the correlation characteristic of the resource use and the temporal characteristic of each resource use according to the combination.

Furthermore, the generation method may further include: (I) calculating a third feature amount that indicates a correlation between resource uses according to a combination of resources which are used by a classification target apparatus based on the second logs respectively related to the plurality of resources which are used by the classification target apparatus; (J) classifying the classification target apparatus by applying the third feature amount to the first apparatus classification rule; (K) calculating a fourth feature amount that indicates the resource usage in each time slot for each of the resources which are used by the classification target apparatus based on the second logs; (L) classifying the classification target apparatus by applying the fourth feature amount to the second apparatus classification rule; and (M) classifying the classification target apparatus by applying a result of third classification according to application of the first apparatus classification rule and a result of fourth classification according to application of the second apparatus classification rule to the third apparatus classification rule.

In this manner, it is possible to more accurately classify the apparatus in relation to the characteristic of the resource use.

Furthermore, a generation method which is executed by a computer that stores a first apparatus classification rule, a second apparatus classification rule, and a third apparatus classification rule which are generated in the above-described process, the generation method may include: (I) calculating a third feature amount that indicates a correlation between resource uses according to a combination of resources which are used by a classification target apparatus based on the second logs respectively related to the plurality of resources which are used by the classification target apparatus; (J) classifying the classification target apparatus by applying the third feature amount to the first apparatus classification rule; (K) calculating a fourth feature amount that indicates the resource usage in each time slot for each of the resources which are used by the classification target apparatus based on the second logs; (L) classifying the classification target apparatus by applying the fourth feature amount to the second apparatus classification rule; and (M) classifying the classification target apparatus by applying a result of third classification according to application of the first apparatus classification rule and a result of fourth classification according to application of the second apparatus classification rule to the third apparatus classification rule.

In this manner, it is easy to apply the rule for classifying the apparatus in relation to the characteristic of the resource use.

Meanwhile, it is possible to prepare a program which causes a computer to perform a process according to the method, and the program may be stored in, for example, a computer-readable storage medium or a storage apparatus such as a flexible disk, a CD-ROM, a magneto-optic disk, a semiconductor memory, or a hard disk. Also, an intermediate processing result is temporally stored in an apparatus such as a general main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a program for causing a computer to execute a process, the process comprising:
calculating, for each of a plurality of apparatuses, a first feature amount that indicates an association between resource uses according to a combination of resources based on first logs related to the resources which are respectively used by the plurality of apparatuses;
performing first clustering on the first feature amount of each of the plurality of apparatuses;
generating a first rule related to the association based on a first result of the first clustering, the first rule corresponding to a procedure that produces a substantially equal result to the first result of the first clustering;
storing the first rule into a memory;
calculating, based on the first logs, a second feature amount that indicates a resource usage in each time slot for each of the resources which are respectively used by the plurality of apparatuses;
performing second clustering on the second feature amount of each of the plurality of apparatuses;
generating a second rule related to the resource usage based on a second result of the second clustering, the second rule corresponding to a procedure that produces a substantially equal result to the second result of the second clustering;
storing the second rule into the memory;
performing third clustering on the plurality of apparatuses based on the first result of the first clustering and the second result of the second clustering;
generating a third rule related to attributes based on a third result of the third clustering, the attributions indicating types of the plurality of apparatus; and
storing the third rule into the memory.

2. The non-transitory computer-readable storage medium according to claim 1, wherein the association between resources uses is a correlation amount between resources uses.

3. The non-transitory computer-readable storage medium according to claim 2, wherein the correlation amount is expressed as a correlation coefficient.

4. The non-transitory computer-readable storage medium according to claim 3, wherein the correlation coefficient is based on a correlation of two resource uses.

5. The non-transitory computer-readable storage medium according to claim 1, wherein
the plurality of apparatus corresponds to a virtual machine respectively, and
the resources of at least one physical machine are virtually allocated to each of the plurality of apparatus according to the attributions.

6. The non-transitory computer-readable storage medium according to claim 3, wherein
the resources include at least two of a processor, a memory, and a network, and
the association is at least one combination between the processor and the memory, the processor and the network, and the memory and the network.

7. The non-transitory computer-readable storage medium according to claim 1, wherein the second feature amount is acquired by normalizing the resource usage of specific time slot based on an average of total time slots.

8. The non-transitory computer-readable storage medium according to claim 1, wherein the first rule is a first classification tree for acquiring the result which is substantially equal to the first result of the first clustering.

9. The non-transitory computer-readable storage medium to claim 8, wherein the first classification tree is generated by a C4.5 classification tree analysis algorithm.

10. The non-transitory computer-readable storage medium according to claim 1, wherein the second rule is a second classification tree for acquiring the result which is substantially equal to the second result of the second clustering.

11. The non-transitory computer-readable storage medium according to claim 10, wherein the second classification tree is generated by a C4.5 classification tree analysis algorithm.

12. The non-transitory computer-readable storage medium according to claim 1, the process further comprising:
outputting information including the attributes of each of the plurality of apparatuses.

13. The non-transitory computer-readable storage medium according to claim 1, wherein
the attributions include at least one of a first type, a second type, and a third type,
the first type is a type of an apparatus that performs a batch process of writing data into a disk at night,
the second type is a type of an apparatus that provides an on-line service in daytime, and
the third type is a type of an apparatus that provides the on-line service all day.

14. The non-transitory computer-readable storage medium according to claim 1, wherein
the third clustering uses first cluster identification information according to the first clustering and second cluster identification information according to the second clustering as attributes, and
the third apparatus classification rule includes at least one of the first cluster identification information and the second cluster identification information as a judgment condition parameter.

15. The non-transitory computer-readable storage medium according to claim 1, the process further comprising:
calculating a third feature amount that indicates another association between the resource uses according to the combination of resources based on second logs related to the plurality of resources which are used by a classification target apparatus that is different from the plurality of apparatuses;
first classifying the third feature amount of the classification target apparatus using the first rule;
calculating, based on the second logs, a fourth feature amount that indicates the resource usage in each time slot for each of the resources which are used by the classification target apparatus;
second classifying the fourth feature amount of the classification target apparatus using the second rule; and
third classifying the classification target apparatus into any one of the attributions based on a result of the first classification and a result of the second classification.

16. The non-transitory computer-readable storage medium according to claim 15, the process further comprising:
outputting information including an attribute of the classification target apparatus according to a result of the third classifying.

17. A classification method executed by a computer, the classification method comprising:
calculating a third feature amount that indicates an association between resource uses according to a combination of resources based on second logs related to a plurality of resources which are used by a classification target apparatus;
first classifying the third feature amount of the classification target apparatus using a first rule related to the association;
calculating, based on the second logs, a fourth feature amount that indicates a resource usage in each time slot for each of the resources which are used by the classification target apparatus;
second classifying the fourth feature amount of the classification target apparatus using a second rule related to the resource usage; and
third classifying the classification target apparatus based on a result of the first classification and a result of the second classification using a third rule related to an attribution indicating type of the classification target apparatus.

18. The classification method according to claim 17, wherein
the first rule is generated with another computer performing a first process, and
the first process includes:
calculating, for each of a plurality of apparatuses, a first feature amount that indicates another association between resource uses according to a combination of resources based on first logs related to the resources which are respectively used by a plurality of apparatuses,
performing first clustering on the first feature amount of each of the plurality of apparatuses, and
generating the first rule based on a first result of the first clustering, the first rule corresponding to a procedure of drawing a result which is substantially equivalent to the first result of the first clustering.

19. The classification method according to claim 18, wherein
the second rule is generated with the another computer performing a second process, and
the second process includes:
calculating, based on the first logs, a second feature amount that indicates the resource usage in each time slot for each of the resources which are respectively used by the plurality of apparatuses,
performing second clustering on the second feature amount of each of the plurality of apparatuses, and
generating the second rule based on a second result of the second clustering, the second rule corresponding to a procedure of drawing a result which is substantially equivalent to the second result of the second clustering.

20. An apparatus comprising:
circuitry configured to:
calculate, for each of a plurality of apparatuses, a first feature amount that indicates an association between resource uses according to a combination of resources based on first logs related to the resources which are respectively used by the plurality of apparatuses,
perform first clustering on the first feature amount of each of the plurality of apparatuses,
generate a first rule related to the association based on a first result of the first clustering, the first rule corresponding to a procedure that produces a substantially equal result to the first result of the first clustering,
store the first rule into a memory,
calculate, based on the first logs, a second feature amount that indicates a resource usage in each time slot for each of the resources which are respectively used by the plurality of apparatuses,
perform second clustering on the second feature amount of each of the plurality of apparatuses,
generate a second rule related to the resource usage based on a second result of the second clustering, the second rule corresponding to a procedure that produces a substantially equal result to the second result of the second clustering,
store the second rule into the memory,
perform third clustering on the plurality of apparatuses based on the first result of the first clustering and the second result of the second clustering,
generate a third rule related to attributes based on a third result of the third clustering, the attributions indicating types of the plurality of apparatus, and
store the third rule into the memory.
